(19) United States
(12) Patent Application Publication
(10) Pub. No.: US 2026/0320756 A1
(43) Pub. Date: Oct. 15, 2026

(54) NEURAL-GUIDED COLOR, TONAL, AND STYLE ENHANCEMENT IN AN IMAGE PROCESSING PIPELINE

(71) Applicants: Dmitry Rudoy, Haifa (IL); Anatoly Litvinov, Binyamina (IL)

(72) Inventors: Dmitry Rudoy, Haifa (IL); Anatoly Litvinov, Binyamina (IL)

(21) Appl. No.: 19/704,922

(22) Filed: Jun. 11, 2026

(51) Int. Cl. G06T 5/60; G06T 3/4046; G06T 5/20

(52) U.S. Cl. CPC G06T 5/60; G06T 3/4046; G06T 5/20

(57) ABSTRACT

Systems and methods are provided for neural-guided image enhancement in an image signal processing pipeline. An input image is processed along a high-resolution processing path and at a neural modifier. The neural modifier processes a reduced-resolution image to generate a modified small image representing one or more color, tonal, or style modifications. A neural-guided incorporator in the high-resolution processing path receives the modified small image and a high-resolution version of the input image. The neural-guided incorporator combines appearance information from the modified small image with detail information from the high-resolution image to generate a high-resolution output image. The neural-guided incorporator can include a finite impulse response filter arrangement that combines low-pass filtered appearance information with high-pass filtered detail information. The neural-guided incorporator can include a pyramid filter arrangement that integrates the modified small image into a multi-resolution representation and reconstructs the high-resolution output image using extracted detail components.

### TECHNICAL FIELD

This disclosure relates generally to image processing, and in particular to incorporating color, tonal, and style enhancement in an image processing pipeline.

### BACKGROUND

Modern image processing systems increasingly use neural or AI-based techniques to perform color, tonal, and style modifications that rely on high-level scene understanding, such as local recoloring, subject relighting, tone mapping, white balance, or style transfer. Applying such techniques directly to full-resolution images, however, is computationally expensive and often impractical for real-time, low-power image processing pipelines. Thus, AI processing may instead be performed on a reduced-resolution version of the image. While lower-resolution processing can efficiently generate a modified appearance, the resulting image lacks fine spatial detail, texture, and edge information needed for a natural high-resolution output. Existing post-processing approaches also suffer from drawbacks because the approaches typically operate after the main image processing pipeline, when bit depth and tonal precision may already be reduced, and because the approaches impose additional full-resolution processing costs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an example image processing system configured to incorporate neural-guided color, tonal, and/or style modifications into a full-resolution image processing pipeline, in accordance with various embodiments.

FIG. 2 illustrates an example neural modifier configured to receive a small RGB image and generate a modified small RGB image, in accordance with various embodiments.

FIG. 3 illustrates an example finite impulse response filter implementation of a neural-guided incorporator, in accordance with various embodiments.

FIG. 4 illustrates an example pyramid filter implementation of a neural-guided incorporator, in accordance with various embodiments.

FIG. 5 illustrates an example tone-mapping application of a neural-guided image processing system, in accordance with various embodiments.

FIG. 6 is a flowchart showing a method for incorporating neural-guided color, tonal, and style enhancements into a hardware image signal processing (ISP) pipeline, in accordance with various embodiments.

FIGS. 7A-7B are flowcharts showing methods for incorporating neural-guided color, tonal, and style enhancements into a hardware ISP pipeline, in accordance with various embodiments.

FIG. 8 is a block diagram of an example deep learning system, in accordance with various embodiments.

FIG. 9 is a block diagram of an example computing device, in accordance with various embodiments.

### DETAILED DESCRIPTION

### Overview

Systems and methods are provided for incorporating neural-guided color, tonal, and style enhancement into image processing pipelines. Modern image processing pipelines increasingly rely on AI-based neural networks to perform sophisticated modifications to color, tonality, and visual style. However, the neural modifications are computationally prohibitive when applied to full-resolution images, and running a neural network on a downscaled version of an image produces a result that lacks the spatial detail, edge sharpness, and fine texture necessary for high-quality output. Prior approaches apply neural modifications as a post-processing step on the full-resolution image after the main pipeline completes, or through iterative optimization-based methods that are computationally unbounded and impractical for hardware integration. Neither approach is well-suited for real-time, power-constrained deployment in camera ISPs and similar embedded systems.

According to various implementations, the disclosed systems and methods include dividing the enhancement task into processing stages. In one stage, a neural modifier operates on a small, low-resolution version of the input image and produces a modified small image that captures the desired color, tonal, or stylistic change at low resolution. In another stage, a dedicated component (a neural-guided incorporator) fuses the modified small image with the original full-resolution image, generating a full-resolution output that reflects the AI-driven modifications while preserving the detail, texture, and edge information of the original sensor capture.

The small image used as input to the neural modifier is generated and retained within the pipeline as a compact replica of the scene, processed similarly to the main image but at a fraction of the resolution. Because neural network complexity scales with image size, confining AI processing to the small image dramatically reduces compute and memory usage without limiting the range of supported modifications. The neural modifier may be any trained network capable of performing the desired transformation (e.g., a U-Net style encoder-decoder), and can be decoupled from the incorporator, making the neural modifier straightforward to update, swap, or retrain as network architectures and user requirements evolve.

The neural modifier supports a broad family of image transformations operating on the small image. The image transformations can include global and local color adjustments (e.g., white balance correction, colorization, and recoloring of specific semantic regions), tonal operations (e.g., subject relighting, local and global tone mapping, and HDR tone compression), and style-level effects (e.g., style transfer). User-driven preferences, such as target hair color or background tint, can be injected into the network via skip connections or conditional inputs during the network's decoder pass, enabling selective modification of specific semantic regions while protecting others. For example, hair and background color can be altered while preserving skin tones.

The neural guided incorporator can be a fixed component embedded within the hardware image processing pipeline, positioned at the color and tonal processing stage. In some examples, the neural guided incorporator can be positioned within the YUV processing block, after demosaicing. The neural guided incorporator receives the upscaled modified small image as a “guide” encoding the desired global look, and the full-resolution raw-derived image including original spatial detail. The function of the neural guided incorporator is to transfer the color, tonality, and style from the guide image into the full-resolution image without introducing blurriness, lost textures, or cartoonish artifacts that result from direct upscaling or naive blending.

The neural guided incorporator can be implemented using various techniques. In a finite impulse response (FIR) implementation, the AI-modified small image is first upscaled to match the full image dimensions and then passed through a low-pass filter (LPF). The LPF extracts the broad color and tonal content while discarding unreliable high-frequency components introduced by upscaling. In parallel, the full-resolution input is passed through a complementary high-pass filter (HPF), isolating textures, edges, and fine structural detail. The LPF filtered output and the HPF filtered output can be summed, yielding a result that combines the AI-driven color and tone from the guide with the spatial fidelity of the original image. In various examples, the LPF and HPF are designed jointly to ensure spectral complementarity, and both the LPF and HPF can be parameterized to control the strength of the applied effect.

Another technique for implementing the neural guided incorporator is a pyramid implementation that includes Laplacian pyramid decomposition for a more artifact-resistant integration. In some examples, the pyramid technique can be particularly suited to cases where the FIR filter pair is difficult to tune or where the pyramid can be shared with other pipeline stages. In the pyramid implementation, the full-resolution input image is iteratively Gaussian-blurred and subsampled, generating a multi-scale representation at full, half, quarter, and one-eighth resolution. At each level, the Laplacian detail band is determined by subtracting the blurred version from the original at the corresponding scale. At the coarsest pyramid level, the AI-modified small image is injected, replacing or blending with the lowest-resolution representation, and effectively substituting the global color and tonal content from the guide. The pyramid is then reconstructed by progressively upsampling and adding back the Laplacian detail bands, restoring full spatial resolution with the new tonal and color characteristics layered in. Optional parameters at the integration level allow control over blend strength or selective application.

According to some implementations, one architectural property of the system is the separation between the updateable neural processing component and the fixed hardware incorporator. The incorporator is a predetermined, bounded filter operation, which can be implemented efficiently in hardware with a fixed number of operations and predictable latency. In contrast, the neural modifier operates outside the hardware pipeline on a separate processing path and can be updated independently as AI technology evolves, without hardware changes. The separation between the updateable neural processing component and the fixed hardware incorporator also means that AI processing cost does not grow with sensor resolution-the neural modifier operates on the small image regardless of the full-resolution capture size.

According to some implementations, the system architecture is hardware-agnostic at the neural modifier level and hardware-efficient at the incorporator level. The incorporator can be implemented in dedicated ISP hardware, as a GPU-accelerated software post-process, or as a fixed IP block in an SoC. Gaussian pyramid operations map well to vectorized GPU implementations. The neural modifier can run on any available AI accelerator (e.g., CPU, GPU, or dedicated NPU). Additionally, the neural modifier can be replaced with a different model or network topology without modifying the incorporator. The system is applicable to still-image capture pipelines, real-time video processing pipelines, and any system where global or regional color, tone, or style modification of high-resolution content is desired.

In various examples, the techniques provided herein provide improved output quality, reduced computational cost, and greater system flexibility compared to post-processing alternatives. By incorporating AI-driven modifications within the color and tonal processing pipeline (rather than as a downstream post-process on an already-processed image), the system operates with full bit depth and avoids the quantization artifacts and limited adjustment range that affect post-processing approaches. Because the incorporator merges details from the original full-resolution image rather than relying on the AI output for spatial content, fine textures, hair strands, edges, and other high-frequency structures are fully preserved in the final result. The computational budget for AI processing remains fixed and small regardless of output resolution, enabling real-time performance at high megapixel counts under power constraints typical of mobile and embedded camera systems.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as implying that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

As used herein, the terms “full-resolution image” and “high-resolution image” may be used interchangeably to refer to image data processed at a higher spatial resolution than a corresponding reduced-resolution image, such as image data processed in a main image processing path of an image signal processing pipeline. The terms “reduced-resolution image,” “low-resolution image,” “small image,” and “small RGB image” may refer to image data representing the same scene or input image at a lower spatial resolution than the full-resolution image. A “small RGB image” is one example of a reduced-resolution image and need not limit the reduced-resolution image to a particular color space unless expressly stated. A reduced-resolution image may be generated by downscaling, subsampling, reduced-resolution image processing, or another reduced-resolution processing path that processes image data in a manner corresponding to, but at a lower resolution than, the full-resolution processing path.

### Example System for ISP Incorporation of Enhancements

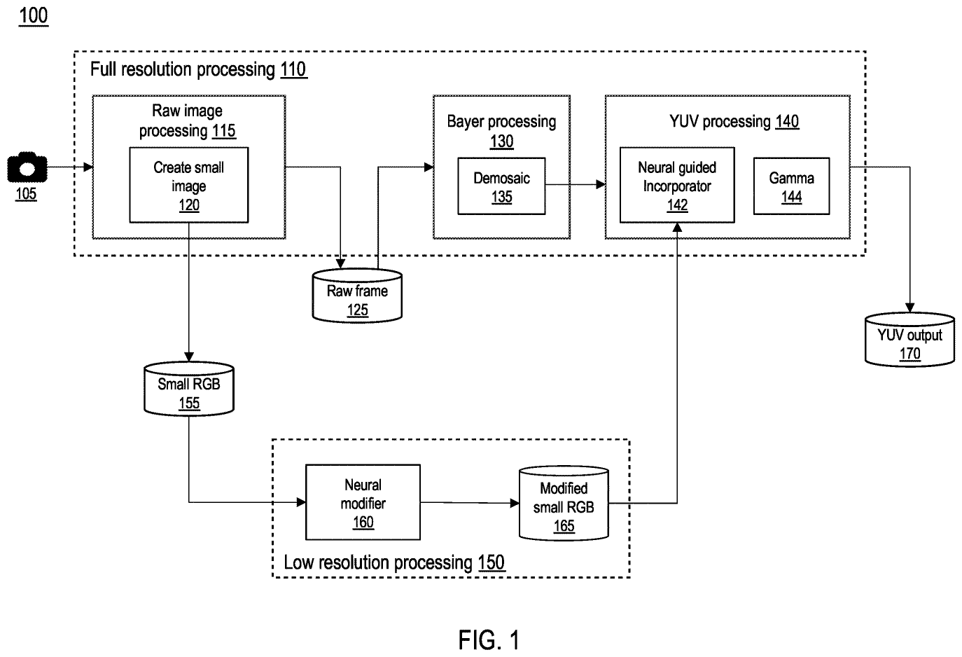

FIG. 1 is a block diagram of an example image processing system 100 configured to incorporate neural-guided color, tonal, and/or style modifications into a full-resolution image processing pipeline, in accordance with various embodiments. In some examples, the system 100 receives image data from an image capture device 105, such as a camera, image sensor, or other image acquisition component. The received image data may include raw image data generated by the image sensor, and the image data is processed along both a full-resolution processing path 110 and a low-resolution processing path 150.

In some examples, the full-resolution processing path 110 processes a full-resolution version of the input image to generate a high-quality output image. The full-resolution processing path 110 may include one or more image signal processing modules, such as a raw image pre-processing module 115, a Bayer processing module 130, and a YUV processing module 140. In some examples, the raw image pre-processing module 115 includes a small image generation module 120 that generates a low-resolution version of the input image. In various examples, the raw image pre-processing module 115 outputs the low-resolution version of the input image to a small RGB storage 155, and a full-resolution version of the input image to a raw frame storage 125. In some examples, the Bayer processing module 130 includes a demosaicing module 135. In some examples, the YUV processing module 140 includes a neural-guided incorporator 142 and a gamma module 144. The full-resolution processing path 110 may preserve fine spatial details of the input image, including edges, textures, hair strands, eyelashes, high-frequency luminance variations, and other image details that may be lost or degraded in a reduced-resolution representation.

In some examples, the low-resolution processing path 150 is generated from the input image by a raw image processing module 115. The raw image processing module 115 may generate a small RGB image, and output a low-resolution version of the input image to a small RGB storage 155. The low-resolution version of the input image may be generated using a reduced-resolution image processing path that processes the small image in a manner corresponding to the full-resolution processing path 110. The low-resolution version of the input image may be suitable for neural analysis while having a resolution that is substantially smaller than the full-resolution image, thereby reducing computational cost.

In some examples, the low-resolution version of the input image is provided to a neural modifier 160. The neural modifier 160 may include any suitable artificial intelligence or neural-network-based image modifier trained or otherwise configured to apply one or more desired visual modifications to the low-resolution version of the input image. The neural modifier 160 may perform, for example, global color adaptation, local color adaptation, dual white balance, local white balance, subject relighting, global tone mapping, local tone mapping, colorization, local recoloring, background tint adjustment, hair color modification, style transfer, or another color, tonal, or style modification.

In some examples, the neural modifier 160 outputs a modified small RGB image 165. The modified small RGB image 165 represents a desired appearance for the final image, but may lack fine image detail because the neural modification is performed at reduced resolution. For instance, the modified small RGB image 165 may contain desired color or tonal information, such as a changed hair color, modified background tint, or relighted scene, while omitting or blurring texture information, edge information, and other fine details required for a natural full-resolution output.

In some examples, user preferences or control inputs are applied at the neural modifier 160 rather than at a downstream incorporator. For example, a neural modifier may be trained or configured to modify hair color, eye color, background color, local illumination, tone mapping, or any combination thereof. In some examples, the neural modifier 160 may use semantic understanding of the image, such as segmentation of hair, skin, background, objects, or other regions, so that selected portions of the image are modified while other portions are preserved. In some examples, a mask or region-selection mechanism may be applied in connection with the neural modifier 160 to localize a desired modification.

In some examples, the modified small RGB image 165 is provided as a guide image to a neural guided incorporator 142 in the full-resolution processing path 110. The neural guided incorporator 142 may be included in the YUV processing module 140 or in another color and/or tonal processing module of the image processing pipeline. By positioning the neural guided incorporator 142 within the main image processing pipeline (i.e., the full-resolution processing path 110), rather than as a full-resolution post-processing block, the system 100 may preserve color precision, tonal precision, bit depth, and spatial detail while avoiding the computational expense of applying neural processing directly to the full-resolution image.

In some examples, the neural guided incorporator 142 receives both the full-resolution image data from the full-resolution processing path 110 and the modified small RGB image 165 from the low-resolution processing path 150. The neural guided incorporator 142 incorporates the visual appearance represented by the modified small RGB image 165 into the full-resolution image data. The incorporation does not include replacing the full-resolution image with an upscaled version of the modified small RGB image 165. Instead, the neural guided incorporator 142 may adjust parameters of the full-resolution image data, such as color values, tone values, luminance values, chrominance values, or style-related appearance characteristics, so that the full-resolution image takes on the desired appearance indicated by the modified small RGB image 165.

In some examples, the neural guided incorporator 142 preserves details from the full-resolution processing path 110 while applying low-frequency or global appearance information from the modified small RGB image 165. For example, the neural guided incorporator 142 may preserve high-frequency details from the original full-resolution image, such as edges and textures, while using the modified small RGB image 165 to guide low-frequency color, tonal, or style characteristics. As a result, the output image may include neural-guided modifications while retaining a natural appearance and avoiding artifacts associated with directly upscaling a low-resolution neural output, such as blurring, loss of texture, or cartoon-like image effects.

In some examples, the neural guided incorporator 142 is implemented using hardware, software, firmware, or a combination thereof. In some examples, the neural guided incorporator 142 is implemented as a fixed or substantially fixed hardware block configured to perform a predefined sequence of image processing operations. In various examples, the neural guided incorporator can be used in real-time image processing, video processing, or low-power imaging devices. In some examples, the neural modifier 160 may be updated, replaced, or retrained over time without changing the neural guided incorporator 142, thereby allowing neural processing capabilities to evolve while maintaining a stable full-resolution incorporation block in the image processing pipeline.

In some examples, after the neural guided incorporator 142 incorporates the modified small RGB image 165 into the full-resolution image data, the YUV processing module 140 may perform additional processing, such as gamma correction at the gamma module 144. The system 100 may then output a YUV output 170. The YUV output 170 may be a full-resolution output image or video frame that includes one or more neural-guided color, tonal, or style modifications derived from the modified small RGB image 165 and also includes fine image details preserved from the full-resolution processing path 110.

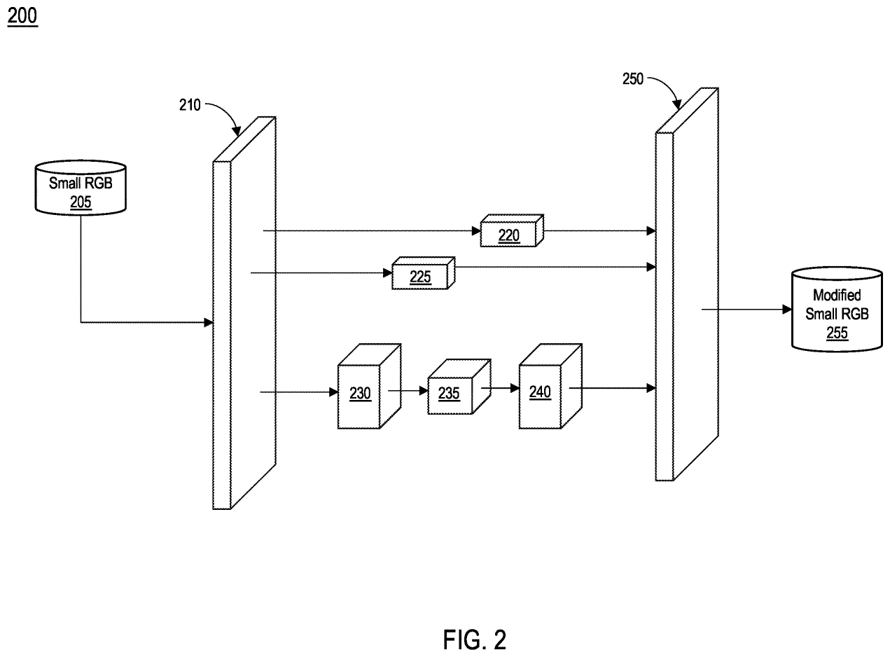

FIG. 2 illustrates an example neural modifier 200 configured to receive a small RGB image 205 and generate a modified small RGB image 255, in accordance with various embodiments. In some examples, the neural modifier 200 corresponds to the neural modifier 160 of the image processing system 100 and operates on a reduced-resolution image rather than a full-resolution image. By operating on the small RGB image 205, the neural modifier 200 may apply computationally expensive AI-based image analysis and modification at a reduced processing cost. The modified small RGB image 255 output from the neural modifier 200 may represent a selected visual appearance, such as a selected color, tonal, or style modification, but the modified small RGB image 255 may lack the fine details that would be present in a corresponding full-resolution image.

In some examples, the small RGB image 205 is a reduced-resolution image generated from an input image, such as by a reduced-resolution processing path. The small RGB image 205 may be provided to an input neural-network layer 210 of the neural modifier 200. The input neural-network layer 210 may perform one or more initial processing operations, such as feature extraction, encoding, semantic analysis, segmentation, or another neural-network operation that identifies or represents portions of the small RGB image 205. For example, the input neural-network layer 210 may contribute to identifying semantic regions such as background, hair, skin, subject regions, object regions, or other portions of the small RGB image 205 that may be modified or preserved.

In some examples, the neural modifier 200 includes one or more intermediate neural-network layers 230, 235, and 240. The intermediate neural-network layer 230 may receive feature information from the input neural-network layer 210 and may perform additional encoding or transformation of the small RGB image 205. The intermediate neural-network layer 235 may further process the features received from the intermediate neural-network layer 230, and the intermediate neural-network layer 240 may further process the features received from the intermediate neural-network layer 235. The intermediate neural-network layers 230, 235, and 240 may collectively implement part of an encoder-decoder, U-Net, convolutional network, transformer-based network, or other suitable neural image modifier architecture.

In some examples, the neural modifier 200

includes a first preference-incorporation element 220 and a second preference-incorporation element 225. The first preference-incorporation element 220 may be disposed along a skip connection or other feature path between the input neural-network layer 210 and an output neural-network layer 250. The first preference-incorporation element 220 may incorporate a first external preference, control input, or modification parameter into the neural modifier 200, such as a background color preference, background tint preference, style preference, or other region-specific appearance preference. The second preference-incorporation element 225 may be disposed along another skip connection or feature path between the input neural-network layer 210 and the output neural-network layer 250. The second preference-incorporation element 225 may incorporate a second external preference, control input, or modification parameter into the neural modifier 200, such as a hair color preference or other subject-region appearance preference.

In some examples, the first preference-incorporation element 220 and the second preference-incorporation element 225 allow the neural modifier 200 to apply different modifications to different semantic regions of the small RGB image 205. For example, the first preference-incorporation element 220 may cause the neural modifier 200 to modify a background region of the small RGB image 205, while the second preference-incorporation element 225 may cause the neural modifier 200 to modify a hair region of the small RGB image 205. In some examples, the neural modifier 200 may include additional topological elements, masks, semantic constraints, or learned constraints so that selected regions are modified while other regions are preserved, such as preserving skin color while changing hair color or background tint.

In some examples, the output neural-network layer 250 receives information from the input neural-network layer 210, the intermediate neural-network layers 230, 235, and 240, the first preference-incorporation element 220, and/or the second preference-incorporation element 225. The output neural-network layer 250 may reconstruct or decode the processed feature information to generate the modified small RGB image 255. The modified small RGB image 255 may therefore include one or more neural-guided modifications, such as global color adaptation, local color adaptation, local white balance, subject relighting, global or local tone mapping, local recoloring, colorization, background modification, hair color modification, or style transfer.

In some examples, the neural modifier 200 is flexible and may be implemented using different neural-network architectures depending on the desired visual effect. For instance, one implementation of the neural modifier 200 may be trained to modify hair color, another implementation of the neural modifier 200 may be trained to perform tone mapping, and another implementation of the neural modifier 200 may be trained to apply style transfer. User inputs specifying what modifications are desired may be handled by the neural modifier 200, including through the first preference-incorporation element 220, the second preference-incorporation element 225, a mask, or another control mechanism. The modified small RGB image 255 may then be used as a guide image by a downstream neural-guided incorporator, which incorporates the appearance of the modified small RGB image 255 into a full-resolution image while preserving fine details from the full-resolution image.

As used herein, “appearance information” may include visual characteristics that define or affect the desired look of an output image, including one or more of color values, tone values, luminance values, chrominance values, white-balance characteristics, local or global tone-mapping characteristics, style characteristics, semantic-region appearance characteristics, or other low-spatial-frequency or guide-image characteristics derived from a modified reduced-resolution image. As used herein, “detail information” may include spatial image information from a full-resolution or high-resolution image, including one or more of edges, textures, hair strands, eyelashes, object boundaries, local contrast, high-frequency luminance variations, band-pass information, or other spatial details that may be absent from or degraded in the modified reduced-resolution image. In the FIR implementation, the low-pass filtered output may provide at least a portion of the appearance information, and the high-pass filtered output may provide at least a portion of the detail information. In the pyramid implementation, the integrated modified low-resolution image may provide at least a portion of the appearance information, and the detail components extracted at multiple pyramid levels may provide at least a portion of the detail information.

### Example FIR Implementation of the Neural-Guided Incorporator

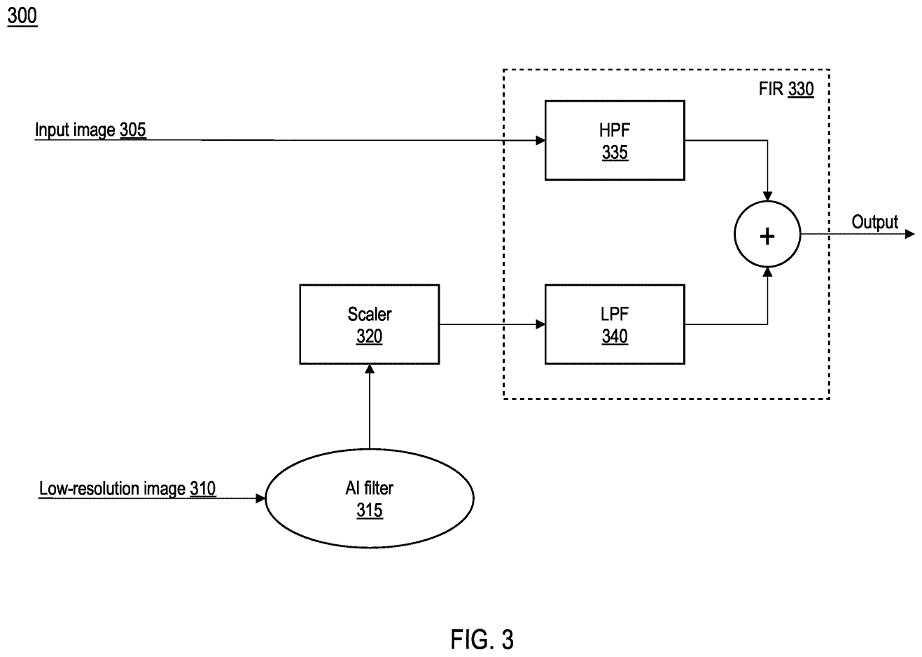

FIG. 3 illustrates an example finite impulse response (FIR) filter implementation 300 of a neural-guided incorporator, in accordance with various embodiments. In some examples, the finite impulse response (FIR) filter implementation 300 receives an input image 305 and a low-resolution image 310. The input image 305 may correspond to a full-resolution or higher-resolution image being processed in a main image processing pipeline. The low-resolution image 310 may correspond to a reduced-resolution version of the input image 305 that is suitable for neural or AI-based processing as described, for example, with respect to FIG. 2.

In some examples, the low-resolution image 310 is provided to an AI filter 315. The AI filter 315 may represent a neural modifier configured to apply one or more desired visual modifications to the low-resolution image 310. For example, the AI filter 315 may modify the low-resolution image 310 to perform color modification, tonal modification, style modification, local recoloring, global color adaptation, local white balance, subject relighting, tone mapping, or another AI-guided image enhancement. The AI filter 315 may output a modified low-resolution image that has a desired visual appearance but lacks fine details due to its reduced resolution. In some examples, the AI filter 315 can be the neural modifier 160 of FIG. 1, and in some examples, the AI filter 315 can be the neural modifier 200 of FIG. 2.

In some examples, the output of the AI filter 315 is provided to a scaler 320. The scaler 320 may upscale the modified low-resolution image from the AI filter 315 so that the scaled image corresponds spatially to the input image 305. The scaler 320 does not recreate high-frequency detail that was absent from the low-resolution image 310. Instead, the scaler 320 may merely bring the modified low-resolution image from the AI filter 315 to a resolution or size suitable for combination with image information derived from the input image 305.

In some examples, the FIR filter implementation 300 includes an FIR block 330. The FIR block 330 may include a high-pass filter 335 and a low-pass filter 340. The FIR block 330 may be implemented in hardware, software, firmware, or a combination thereof. In some examples, the FIR block 330 is implemented as part of a color or tonal processing stage of an image processing pipeline so that the modification represented by the low-resolution image 310 can be incorporated before final image output, rather than as a full-resolution post-processing operation.

In some examples, the input image 305 is provided to the high-pass filter 335 of the FIR block 330. The high-pass filter 335 may extract high-frequency image information from the input image 305. The high-frequency image information may include textures, edges, fine spatial details, hair strands, eyelashes, object boundaries, local contrast information, and other detail information that contributes to a natural full-resolution appearance. In various examples, the high-pass filter 335 allows the FIR filter implementation 300 to retain details from the input image 305 rather than relying on details from the low-resolution image 310.

In some examples, the scaled output from the scaler 320 is provided to the low-pass filter 340 of the FIR block 330. The low-pass filter 340 may extract or retain low-frequency image information from the modified low-resolution image generated from the low-resolution image 310 by the AI filter 315 and the scaler 320. The low-frequency image information may represent the general visual appearance of the desired neural modification, including overall color, tone, luminance, chrominance, style, or other low-frequency appearance characteristics. Because the modified low-resolution image from the AI filter 315 may lack fine details, the low-pass filter 340 may reject or suppress high-frequency components that are not reliable or not useful for producing a natural full-resolution output.

In some examples, the high-pass filter 335 and the low-pass filter 340 are designed in conjunction with one another. For instance, filter coefficients, filter sizes, cutoff frequencies, weights, or other parameters of the high-pass filter 335 and the low-pass filter 340 may be selected so that the output of the high-pass filter 335 and the output of the low-pass filter 340 combine to generate a visually consistent result. In some examples, one or more parameters of the high-pass filter 335, the low-pass filter 340, and/or the FIR block 330 may be fixed for a particular image processing pipeline. In other examples, one or more parameters of the high-pass filter 335, the low-pass filter 340, and/or the FIR block 330 may be adjustable to control the strength of the neural-guided effect and/or to accommodate different image sizes, power constraints, and/or desired detail levels.

In some examples, the FIR block 330 combines the output of the high-pass filter 335 and the output of the low-pass filter 340 to generate an output image. The output image of the FIR filter implementation 300 may therefore include visual appearance information derived from the low-resolution image 310 as modified by the AI filter 315, while preserving detail information derived from the input image 305. Thus, the FIR filter implementation 300 may generate a full-resolution output image that has the colors, tones, or style of the AI-modified low-resolution image, while retaining natural texture and edge information from the input image 305.

### Example Pyramid Implementation of the Neural-Guided Incorporator

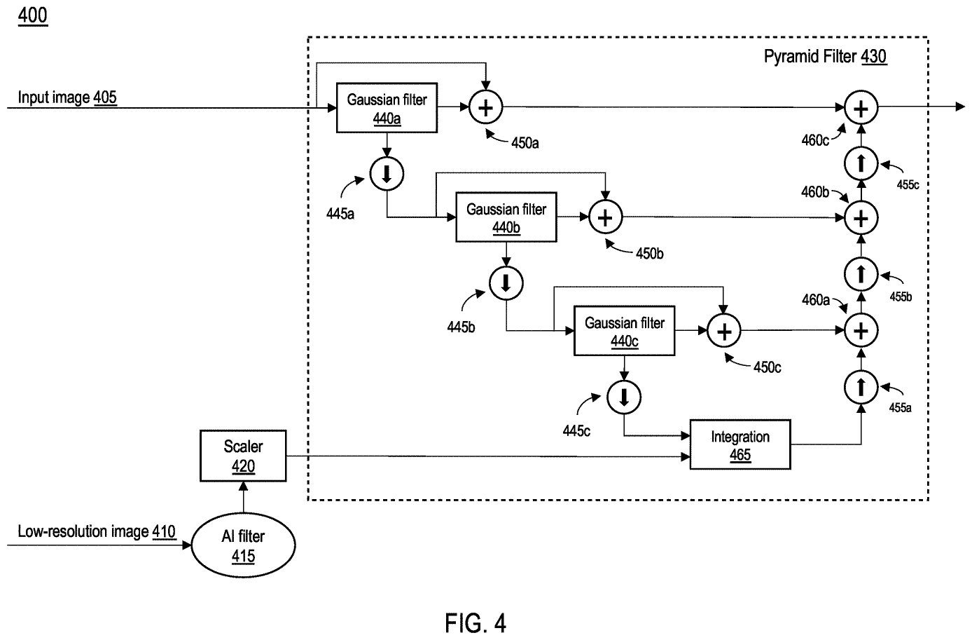

FIG. 4 illustrates an example pyramid filter implementation 400 of a neural-guided incorporator, in accordance with various embodiments. In some examples, the pyramid filter implementation 400 receives an input image 405 and a low-resolution image 410. The input image 405 may correspond to a full-resolution or higher-resolution image in a main image processing path, and the low-resolution image 410 may correspond to a reduced-resolution version of the input image 405 that is provided to a neural or AI-based processing path.

In some examples, the low-resolution image 410 is provided to an AI filter 415. The AI filter 415 may apply one or more desired visual modifications to the low-resolution image 410. For example, the AI filter 415 may perform color modification, tonal modification, style modification, local recoloring, background tint adjustment, hair color modification, subject relighting, local or global tone mapping, white balance adjustment, or another neural-guided enhancement. The AI filter 415 may output a modified low-resolution image that provides a guide for the desired final image appearance. In some examples, the AI filter 415 can be the neural modifier 160 of FIG. 1, and in some examples, the AI filter 415 can be the neural modifier 200 of FIG. 2.

In some examples, the modified low-resolution image output by the AI filter 415 is provided to a scaler 420. The scaler 420 adapts the modified low-resolution image from the AI filter 415 so that the modified low-resolution image corresponds to a selected level of a pyramid filter 430. For example, the scaler 420 may resample, interpolate, upscale, downscale, or otherwise spatially align the output of the AI filter 415 with a low-resolution level of the pyramid filter 430. In some examples, the scaler 420 may additionally or alternatively apply filtering to align a blur level of the modified low-resolution image with the selected level of the pyramid filter 430.

In some examples, the pyramid filter implementation 400 includes a pyramid filter 430. The pyramid filter 430 may generate a multi-resolution representation of the input image 405 and may reconstruct an output image using the modified low-resolution image generated from the low-resolution image 410. The pyramid filter 430 may be implemented using a Laplacian pyramid, a Gaussian pyramid, or another multi-resolution filtering arrangement. In some examples, the pyramid filter 430 is configured to perform a predefined number of operations, such that the pyramid filter 430 can be implemented efficiently in hardware, software, graphics processing hardware, image signal processing hardware, or another image processing pipeline.

The pyramid filter 430 receives the input image 405 and generates a multi-resolution representation of the input image 405. In some examples, the pyramid filter 430 includes a first Gaussian filter 440a, a second Gaussian filter 440b, and a third Gaussian filter 440c. The first Gaussian filter 440a receives the input image 405, the second Gaussian filter 440b receives a downsampled image generated from the output of the first Gaussian filter 440a, and the third Gaussian filter 440c receives a further downsampled image generated from the output of the second Gaussian filter 440b. Although three Gaussian filters 440a, 440b, and 440c are shown, additional or fewer pyramid levels may be used.

In some examples, the pyramid filter 430 includes a first downsampler 445a, a second downsampler 445b, and a third downsampler 445c. The first downsampler 445a reduces a resolution of an image derived from the first Gaussian filter 440a. The second downsampler 445b reduces a resolution of an image derived from the second Gaussian filter 440b. The third downsampler 445c reduces a resolution of an image derived from the third Gaussian filter 440c. In some examples, each of the first downsampler 445a, the second downsampler 445b, and the third downsampler 445c reduces resolution by a factor of two, although other scale factors may be used. Thus, in some examples, the first downsampler 445a outputs a ½-resolution image, the second downsampler 445b outputs a ¼-resolution image, and the third downsampler 445c outputs a ⅛-resolution image.

In some examples, the pyramid filter 430 includes a first combiner 450a, a second combiner 450b, and a third combiner 450c. The first combiner 450a receives information corresponding to the input image 405 and information derived from the first Gaussian filter 440a to generate a first detail component. The second combiner 450b receives information corresponding to an intermediate-resolution representation from the first downsampler 445a and information derived from the second Gaussian filter 440b to generate a second detail component. The third combiner 450c receives information corresponding to a further intermediate-resolution representation from the second downsampler 445b and information derived from the third Gaussian filter 440c to generate a third detail component. In some examples, the first combiner 450a, the second combiner 450b, and the third combiner 450c may perform subtraction, addition of a signed component, differencing, or another combination operation that separates detail information from lower-frequency image information.

In some examples, the detail components generated using the first combiner 450a, the second combiner 450b, and the third combiner 450c preserve high-frequency or band-pass information from the input image 405. Such detail information may include edges, textures, hair strands, eyelashes, object boundaries, local contrast, and other spatial details that may be absent from the output of the AI filter 415. Thus, in various examples, the pyramid filter 430 uses the input image 405 as the source of image detail and uses the low-resolution image 410, after processing by the AI filter 415 and the scaler 420, as a guide for color, tone, style, or other low-frequency visual appearance.

In some examples, the pyramid filter 430 includes an integration block 465. The integration block 465 receives the modified low-resolution image from the scaler 420 and also receives a low-resolution pyramid representation generated from the input image 405 through the first Gaussian filter 440a, the first downsampler 445a, the second Gaussian filter 440b, the second downsampler 445b, the third Gaussian filter 440c, and the third downsampler 445c. The integration block 465 integrates the modified low-resolution image into the low-resolution pyramid representation. In some examples, the integration block 465 replaces the low-resolution pyramid representation with the modified low-resolution image. In other examples, the integration block 465 blends, averages, interpolates, weights, or otherwise combines the modified low-resolution image with the low-resolution pyramid representation.

In some examples, the integration block 465 performs the primary incorporation of the neural-guided appearance information into the pyramid filter 430. For example, the integration block 465 may inject colors, tones, luminance changes, chrominance changes, or style characteristics from the modified low-resolution image into the reconstruction path of the pyramid filter 430. In some examples, the integration block 465 may integrate the modified low-resolution image across the entire image. In other examples, the integration block 465 may integrate the modified low-resolution image according to a mask, semantic region, or control parameter, such that a neural-guided modification is applied to selected regions of the input image 405.

In some examples, the pyramid filter 430 further includes a first upsampler 455a, a second upsampler 455b, and a third upsampler 455c, as well as a first reconstruction combiner 460a, a second reconstruction combiner 460b, and a third reconstruction combiner 460c. The first upsampler 455a upsamples the output of the integration block 450, and the first reconstruction combiner 460a combines the upsampled output of the first upsampler 455a with the detail component generated by the third combiner 450c. The second upsampler 455b upsamples the output of the first reconstruction combiner 460a, and the second reconstruction combiner 460b combines the upsampled output of the second upsampler 455b with the detail component generated by the second combiner 450b. The third upsampler 455c upsamples the output of the second reconstruction combiner 460b, and the third reconstruction combiner 460c combines the upsampled output of the third upsampler 455c with the detail component generated by the first combiner 450a.

The output of the third reconstruction combiner 460c may be a full-resolution output image of the pyramid filter implementation 400. In some examples, the full-resolution output image has color, tonal, or style characteristics derived from the low-resolution image 410 after processing by the AI filter 415, while preserving detail information derived from the input image 405 through the first detail combiner 450a, the second detail combiner 450b, and the third detail combiner 450c. Thus, in various examples, the pyramid filter implementation 400 may incorporate neural-guided modifications without performing full-resolution neural image generation and without merely upscaling the output of the AI filter 415. The pyramid filter implementation 400 may thereby provide a natural-looking full-resolution image with preserved edges and textures and with reduced blur, reduced cartoon-like artifacts, and improved suitability for real-time, low-power, hardware, software, image signal processor, or graphics-processing-unit implementation.

### Example Images Using ISP Incorporation of Enhancements

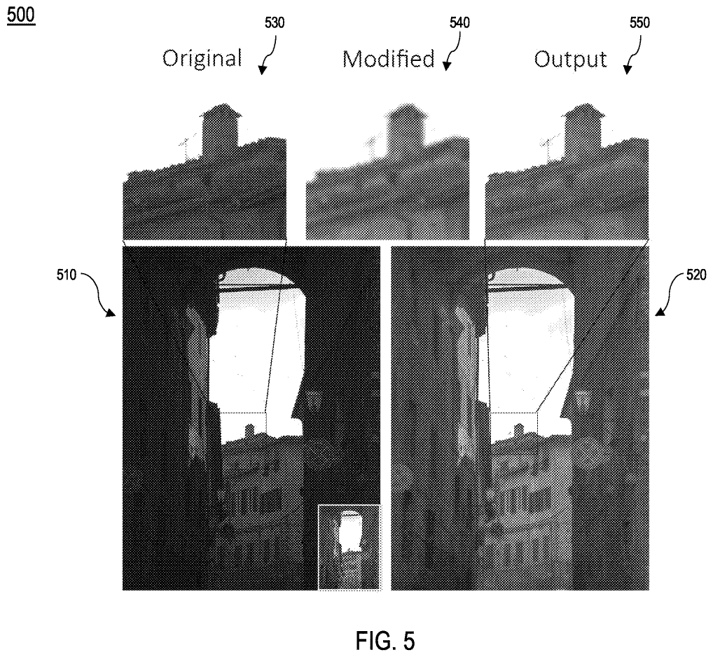

FIG. 5 illustrates an example tone-mapping application 500 of a neural-guided image processing system, in accordance with various embodiments. In some examples, the tone-mapping application 500 demonstrates how a low-resolution neural modification may be incorporated into a full-resolution image while preserving details from the full-resolution image. The tone-mapping application 500 includes an original image 510, an output image 520, an enlarged original region 530, an enlarged modified region 540, and an enlarged output region 550.

In some examples, the original image 510 is a full-resolution or higher-resolution image captured by an image sensor or otherwise provided to an image processing pipeline. The original image 510 may include regions having low visibility, low brightness, high contrast, or otherwise difficult tonal characteristics. For example, the original image 510 may include a scene in which side buildings, walls, architectural details, or other regions are dark or difficult to discern. The original image 510 may nevertheless include fine image details, such as edges, rooflines, wires, object boundaries, texture on walls, and other spatial information that should be preserved in a final output image.

In some examples, the enlarged original region 530 is an enlarged portion of the original image 510. The enlarged original region 530 may show that the original image 510 includes fine spatial detail, such as an edge of a building, a chimney, an antenna, a cable, a roof structure, or another high-frequency detail. The enlarged original region 530 may also show that, despite the presence of such fine spatial detail in the original image 510, portions of the original image 510 may have tonal characteristics that make some scene content difficult to perceive.

In some examples, the enlarged modified region 540 represents a portion of a modified low-resolution image generated by a neural modifier, AI filter, tone-mapping network, HDRNet-type model, or other neural image modifier operating on a reduced-resolution version of the original image 510. The enlarged modified region 540 may show a desired tonal correction, such as increased visibility of dark regions or a corrected global or local brightness distribution. However, because the enlarged modified region 540 is derived from low-resolution neural processing, the enlarged modified region 540 may lack fine image detail and may appear blurred relative to the enlarged original region 530.

In some examples, the neural modifier used to produce the modified image corresponding to the enlarged modified region 540 may operate on a small image rather than on the full-resolution original image 510. Operating on the small image may substantially reduce processing cost, power consumption, and latency relative to applying neural tone mapping directly to the original image 510. However, the modified low-resolution image corresponding to the enlarged modified region 540 may be unsuitable for direct use as a final image because the modified low-resolution image may lose or degrade textures, edges, and other high-frequency details.

In some examples, the output image 520 is generated by incorporating the tonal information represented by the modified low-resolution image into the original image 510. For example, a neural-guided incorporator may receive the original image 510 and the modified low-resolution image corresponding to the enlarged modified region 540 and may generate the output image 520 by combining tones from the modified low-resolution image with details from the original image 510. The output image 520 may therefore include improved visibility or corrected tonality relative to the original image 510 while preserving spatial detail from the original image 510.

In some examples, the enlarged output region 550 is an enlarged portion of the output image 520 corresponding to the enlarged original region 530 and the enlarged modified region 540. The enlarged output region 550 may show that details from the enlarged original region 530, such as rooflines, chimney edges, antennas, cables, or other fine structures, are preserved in the output image 520 even though the output image 520 has tonal characteristics guided by the modified low-resolution image. Thus, the enlarged output region 550 may demonstrate that the system does not merely upscale the low-resolution neural output, but instead transfers tonal appearance from the low-resolution neural output while retaining high-frequency detail from the original image 510.

In some examples, the tone-mapping application 500 illustrates that the disclosed system can be used for intense tonal adjustments in addition to color or style modifications. The output image 520 may preserve a natural appearance by avoiding the loss of detail that would result from directly using the modified low-resolution image represented by the enlarged modified region 540. In some examples, if extreme tone mapping introduces a perceived softness or blurriness in portions of the output image 520, sharpening or another downstream image enhancement may be applied to the output image 520 while still retaining the benefits of neural-guided tone incorporation.

### Example Method for ISP Incorporation of Enhancements

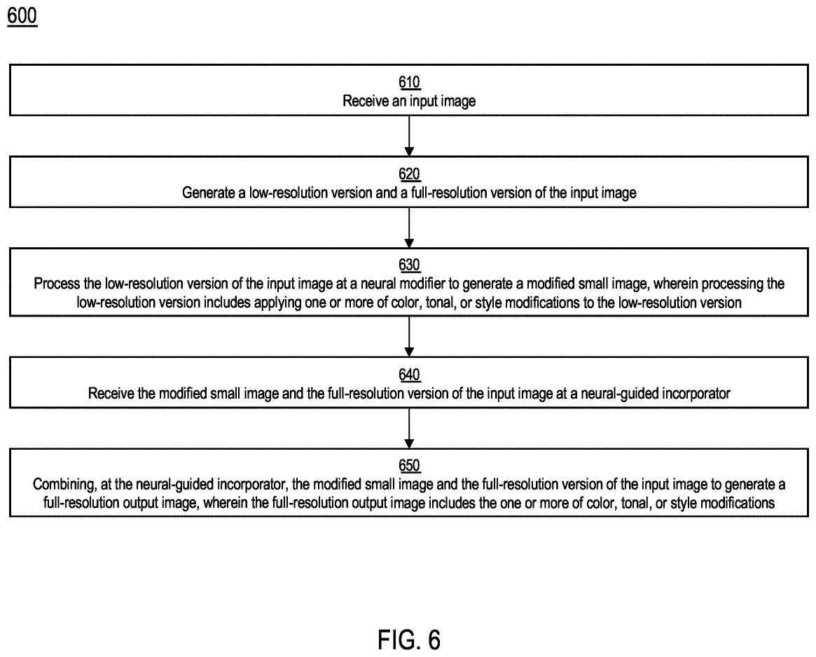

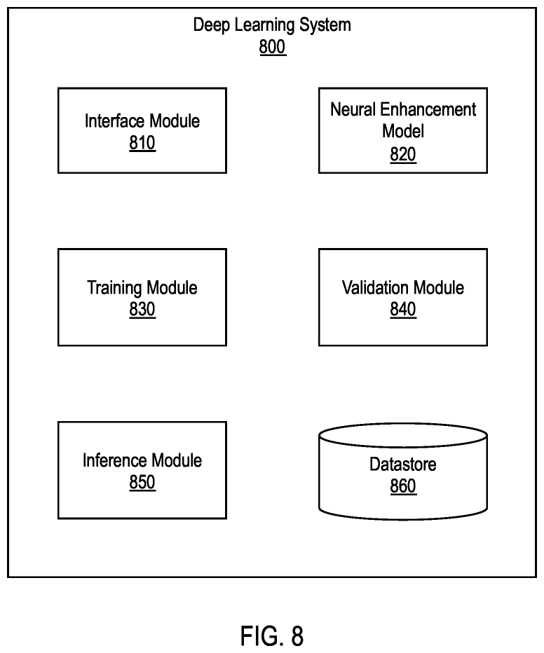

FIG. 6 is a flowchart showing a method 600 for incorporating neural-guided color, tonal, and style enhancements into a hardware image signal processing (ISP) pipeline, in accordance with various embodiments. In some examples, the method 600 may be used for video processing, including for real-time video conferencing. The method 600 may be performed by the systems of FIGS. 1-4, and/or by the deep learning system 800 in FIG. 8. Although the method 600 is described with reference to the flowchart illustrated in FIG. 6, other methods may alternatively be used. For example, the order of execution of the steps in FIG. 6 may be changed. As another example, some of the steps may be changed, eliminated, or combined.

At 610, the method 600 includes receiving an input image. In some examples, the input image received at block 610 may include raw image data generated by an image sensor, such as a Bayer-domain image frame, an RGB image, a YUV image, or another image representation. In some examples, the input image received at 610 may be a still image or one frame of a video stream. In some examples, the input image received at 610 may be received by an ISP pipeline configured to perform real-time or low-power image processing while preserving image detail, bit depth, color precision, and tonal precision.

At 620, the method 600 includes generating a low-resolution version and a full-resolution version of the input image. In some examples, the low-resolution version generated at 620 may be a small RGB image generated from the input image received at 610, for example using a reduced-resolution processing path. The low-resolution version generated at 620 may be processed similarly to the full-resolution version generated at 620, but at a reduced image size suitable for neural processing. In some examples, the full-resolution version generated at 620 may be provided through a main ISP pipeline, such as a pipeline including raw-frame processing, Bayer processing, demosaicing, color processing, tonal processing, YUV processing, gamma processing, or any combination thereof.

At 630, the method 600 includes processing the low-resolution version of the input image at a neural modifier to generate a modified small image. In some examples, the processing at block 630 includes applying one or more of color, tonal, or style modifications to the low-resolution version. For example, the neural modifier used at block 630 may perform global color adaptation, local color adaptation, local white balance, subject relighting, local recoloring, background tint adjustment, hair color modification, global tone mapping, local tone mapping, colorization, style transfer, or another neural-guided image modification. In some examples, user inputs, masks, semantic-region selections, or preference values may be applied at block 630 by the neural modifier, such that the modified small image generated at block 630 has a desired visual appearance.

In some examples, the modified small image generated at 630 may include color, tone, luminance, chrominance, or style information representing the desired final image appearance, but may lack fine details due to the reduced resolution of the low-resolution version processed at 630. For example, the modified small image generated at 630 may indicate a desired hair color, background tint, relighting effect, or tone-mapped appearance, while lacking fine details such as hair strands, eyelashes, edges, textures, object boundaries, architectural details, or other high-frequency spatial information. Accordingly, the modified small image generated at 630 may be used as a guide image rather than as a replacement for the full-resolution version generated at 620.

At 640, the method 600 includes receiving the modified small image and the full-resolution version of the input image at a neural-guided incorporator. In some examples, the neural-guided incorporator at 640 is positioned in a color or tonal processing stage of the ISP pipeline so that the neural-guided modification can be incorporated during main image processing rather than as a full-resolution post-processing operation. In some examples, the neural-guided incorporator at 640 is implemented in hardware, software, firmware, graphics processing hardware, ISP circuitry, or a combination thereof. In some examples, the neural-guided incorporator at 640 may be fixed or substantially fixed in the ISP pipeline, while the neural modifier used at 630 may be updated, replaced, or retrained to perform different visual modifications.

At 650, the method 600 includes combining, at the neural-guided incorporator, the modified small image and the full-resolution version of the input image to generate a full-resolution output image. In some examples, the full-resolution output image generated at 650 includes the one or more color, tonal, or style modifications generated at 630, while preserving spatial details from the full-resolution version generated at 620. The combining at 650 may include modifying color values, tonal values, luminance values, chrominance values, or style-related appearance characteristics of the full-resolution version based on the modified small image, rather than replacing the full-resolution version with an upscaled version of the modified small image. In this manner, the full-resolution output image generated at 650 may preserve a natural image appearance while reducing blur, texture loss, and cartoon-like artifacts associated with direct use of low-resolution neural output.

In some examples, the combining at 650 is performed using a finite impulse response (FIR) embodiment of the neural-guided incorporator. In such examples, the modified small image may be scaled to correspond to the full-resolution version, processed using a low-pass filter to extract low-frequency visual appearance information, and combined with high-frequency detail information extracted from the full-resolution version using a high-pass filter. The low-pass filter and the high-pass filter may be designed together so that low-frequency color, tonal, or style information from the modified small image is combined with texture, edge, and detail information from the full-resolution version. In some examples, filter coefficients, cutoff frequencies, filter sizes, blending weights, or effect-strength parameters used at block 650 may be fixed, calibrated, user-adjustable, system-adjustable, or otherwise selected based on image size, desired detail level, power constraints, or desired modification strength.

In some examples, the combining at 650 is performed using a pyramid-filter embodiment of the neural-guided incorporator. In such examples, the full-resolution version may be decomposed into a multi-resolution representation using Gaussian filtering, downsampling, and detail extraction operations. The modified small image may be scaled or blur-matched to a selected pyramid level and integrated into the multi-resolution representation, such as by replacement, blending, averaging, interpolation, weighted combination, or region-specific integration. The full-resolution output image may then be reconstructed by upsampling from the selected pyramid level and adding detail components from the full-resolution version at successively higher resolution levels. Thus, the pyramid-filter embodiment used at 650 may inject the neural-guided color, tonal, or style appearance of the modified small image while restoring fine image details from the full-resolution version.

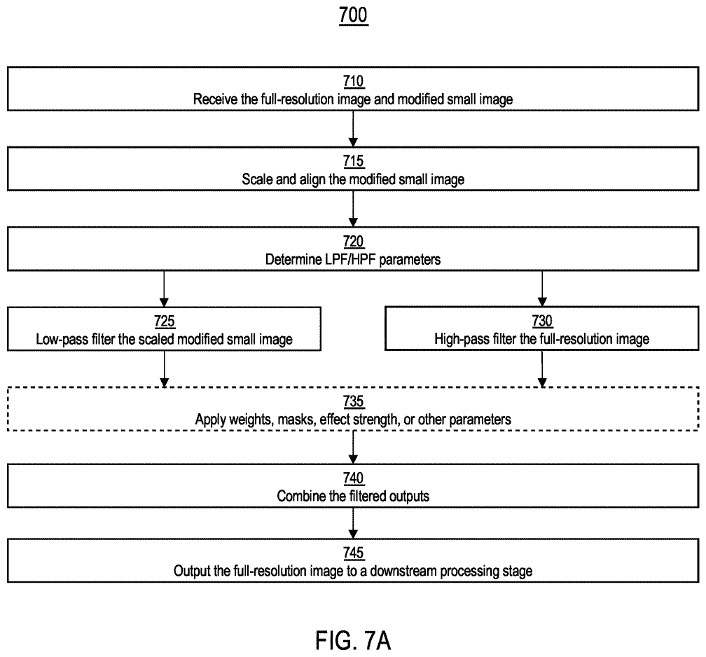

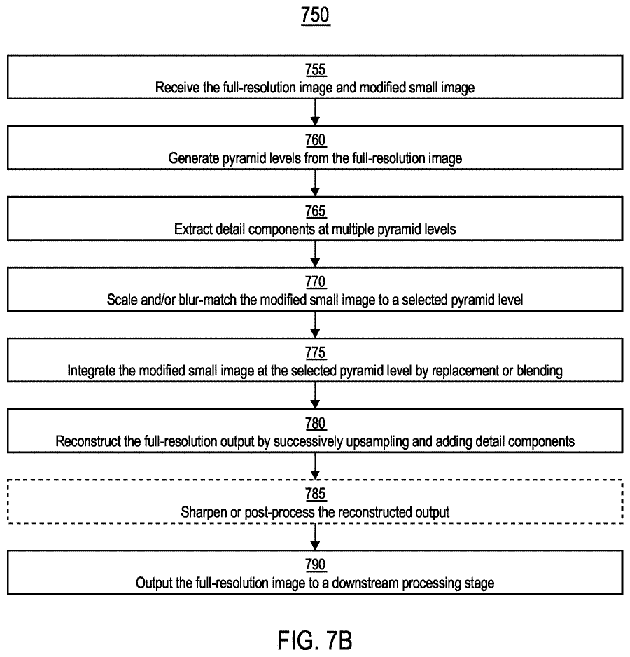

FIGS. 7A-7B are flowcharts showing methods 700 and 750, respectively, for incorporating neural-guided color, tonal, and style enhancements into a hardware ISP pipeline, in accordance with various embodiments. In some examples, the methods 700 and 750 may be used for video processing, including for real-time video conferencing. The methods 700 and 750 may be performed by the systems of FIGS. 1-4, and/or by the deep learning system 800 in FIG. 8. Although the methods 700 and 750 are described with reference to the flowcharts illustrated in FIGS. 7A-7B, other methods may alternatively be used. For example, the order of execution of the steps in FIGS. 7A-7B may be changed. As another example, some of the steps may be changed, eliminated, or combined.

FIG. 7A illustrates the method 700 for incorporating a modified small image into a full-resolution image using a FIR implementation of a neural-guided incorporator, such as the FIR implementation 300 of FIG. 3. At 710, the method 700 includes receiving the full-resolution image and the modified small image. In some examples, the full-resolution image received at 710 corresponds to the input image 305 of FIG. 3, and the modified small image received at 710 corresponds to an output of the AI filter 315 generated from the low-resolution image 310 of FIG. 3. The modified small image received at 710 may include color, tonal, or style information generated by a neural modifier, while the full-resolution image received at 710 may include fine spatial details to be preserved in a final output.

At 715, the method 700 includes scaling and aligning the modified small image. In some examples, the scaling and aligning at 715 may be performed by the scaler 320 of FIG. 3. Scaling and aligning the modified small image at 715 may include upscaling, resampling, interpolating, registering, or otherwise adapting the modified small image so that the modified small image spatially corresponds to the full-resolution image received at 710. In some examples, the scaling and aligning at 715 do not recreate details that are absent from the modified small image, but instead prepare the modified small image for use as a guide image for low-frequency visual appearance information.

At 720, the method 700 includes determining low-pass filter/high-pass filter parameters. In some examples, the parameters determined at 720 may include coefficients, cutoff frequencies, filter sizes, weights, gains, blending parameters, effect-strength parameters, or other settings for a low-pass filter and a high-pass filter. In some examples, the low-pass filter and the high-pass filter may be designed together so that low-frequency visual appearance information from the modified small image and high-frequency detail information from the full-resolution image combine to produce a natural full-resolution output. The parameters determined at 720 may be predetermined, calibrated, selected based on image size, selected based on a desired detail level, selected based on power or performance constraints, or adjusted based on a user or system setting.

At 725, the method 700 includes low-pass filtering the scaled modified small image. In some examples, the low-pass filtering at 725 may be performed by the low-pass filter 340 of FIG. 3. The low-pass filtering at 725 may retain or extract low-frequency appearance information from the scaled modified small image, such as color, tone, luminance, chrominance, style, or other general appearance characteristics. In some examples, the low-pass filtering at 725 may reject or suppress unreliable high-frequency components of the scaled modified small image, because the modified small image may lack true fine details due to being generated by neural processing at reduced resolution.

At 735, the method 700 optionally includes applying weights, masks, effect-strength, and/or other parameters. In some examples, the optional weights, masks, effect-strength, and/or other parameters may optionally be applied to one or both of the low-pass filtered modified small image generated at 725, the high-pass filtered full-resolution image generated at 730, or a combination of the low-pass filtered modified small image and the high-pass filtered full-resolution image. For example, the optional weights, masks, effect-strength, and/or other parameters may control how strongly a neural-guided color, tonal, or style modification is applied, how much high-frequency detail is preserved or restored, or where the modification is applied within the image. In some examples, the optional weights, masks, effect-strength, and/or other parameters may use a spatial mask, semantic-region mask, user-selected effect-strength value, system-selected gain, or blending weight, such as to apply an effect at less than full strength or to apply the effect only to selected regions of the image. In some examples, no weights, masks, effect-strength, or other parameters are applied to either the low-pass filtered modified small image or the high-pass filtered full-resolution image.

At 740, the method 700 includes combining the filtered outputs from 725 and 730 (or from 735). In some examples, the combining at 740 may be performed by the FIR block 330 of FIG. 3, such as by adding or otherwise combining the low-pass filtered modified small image generated at 725 and the high-pass filtered full-resolution image generated at 730. The resulting image may include low-frequency color, tonal, or style information derived from the modified small image and high-frequency texture or edge information derived from the full-resolution image. At 745, the method 700 includes outputting the full-resolution image to a downstream processing stage. In some examples, the full-resolution image output at 745 may be provided to a gamma stage, YUV processing stage, sharpening stage, display pipeline, encoder, memory, or another downstream processing stage.

FIG. 7B illustrates a method 750 for incorporating a modified small image into a full-resolution image using a pyramid-filter implementation of a neural-guided incorporator, such as the pyramid filter implementation 400 of FIG. 4. At 755, the method 750 includes receiving the full-resolution image and the modified small image. In some examples, the full-resolution image received at 755 corresponds to the input image 405 of FIG. 4, and the modified small image received at 755 corresponds to an output of the AI filter 415 and/or the scaler 420 generated from the low-resolution image 410 of FIG. 4. The modified small image received at 755 may include a desired visual appearance generated by neural processing, while the full-resolution image received at block 755 may include image details to be retained.

At 760, the method 750 includes generating pyramid levels from the full-resolution image. In some examples, the generating at 760 may be performed by the pyramid filter 430 of FIG. 4 using Gaussian filtering and downsampling. For example, the generating at 760 may use one or more Gaussian filters, such as the Gaussian filters 440a, 440b, and 440c of FIG. 4, and one or more downsamplers, such as the downsamplers 445a, 445b, and 445c of FIG. 4. The pyramid levels generated at 760 may include a full-resolution level, a half-resolution level, a quarter-resolution level, an eighth-resolution level, or other levels depending on the implementation.

At 765, the method 750 includes extracting detail components at multiple pyramid levels. In some examples, the extracting at 765 may be performed using combiners, such as the combiners 450a, 450b, and 450c of FIG. 4. The detail components extracted at 765 may represent band-pass or high-frequency information at different resolutions. For example, the detail components extracted at 765 may include texture, edge information, local contrast, hair strands, eyelashes, rooflines, wires, object boundaries, or other spatial details. In some examples, the detail components extracted at 765 may have positive or negative values and may be generated by subtracting or otherwise differencing a blurred representation from a corresponding higher-resolution representation.

At 770, the method 750 includes scaling and/or blur-matching the modified small image to a selected pyramid level. In some examples, the scaling and/or blur-matching at 770 may be performed by the scaler 420 of FIG. 4. The selected pyramid level may be a lowest pyramid level or another level selected based on the resolution of the modified small image, the type of neural-guided modification, the desired strength of the modification, hardware constraints, or image quality considerations. In some examples, the scaling and/or blur-matching at 770 aligns the modified small image with a pyramid level so that the modified small image can be integrated without introducing size mismatch artifacts or blur mismatch artifacts.

At 775, the method 750 includes integrating the modified small image at the selected pyramid level by replacement or blending. In some examples, the integrating at 775 may be performed by the integration block 465 of FIG. 4. The integrating at 775 may include replacing a low-resolution pyramid representation derived from the full-resolution image with the modified small image. In other examples, the integrating at 775 may include blending, averaging, interpolating, weighting, or otherwise combining the modified small image with the low-resolution pyramid representation. In some examples, the integrating at 775 may be performed across the entire image or may be performed according to a mask, semantic region, or other control information so that the neural-guided modification is applied to selected portions of the image.

At 780, the method 750 includes reconstructing the full-resolution output by successively upsampling and adding detail components. In some examples, the reconstructing at 780 may be performed by the pyramid filter 430 of FIG. 4 using upsamplers, such as the upsamplers 455a, 455b, and 455c of FIG. 4, and reconstruction combiners, such as the reconstruction combiners 460a, 460b, and 460c of FIG. 4. The reconstructing at 780 may begin from the selected pyramid level into which the modified small image was integrated at 775, and may progressively restore detail components extracted at 765. Accordingly, the reconstructed full-resolution output may have color, tone, or style characteristics of the modified small image and detail characteristics of the full-resolution image.

At 785, the method 750 optionally includes sharpening or post-processing the reconstructed output. In some examples, the sharpening or post-processing at 785 may compensate for perceived softness or blurriness that may occur with strong neural-guided tone mapping or other large appearance changes. The optional sharpening or post-processing at 785 may include edge enhancement, contrast enhancement, detail enhancement, denoising, artifact reduction, gamma correction, color correction, YUV processing, or another downstream or in-pipeline image processing operation. At 790, the method 750 includes outputting the full-resolution image to a downstream processing stage. In some examples, the full-resolution image output at 790 may be a natural-looking high-resolution image or video frame that incorporates one or more neural-guided color, tonal, or style modifications while preserving original image details and textures.

### Example DNN System for ISP Incorporation of Enhancements

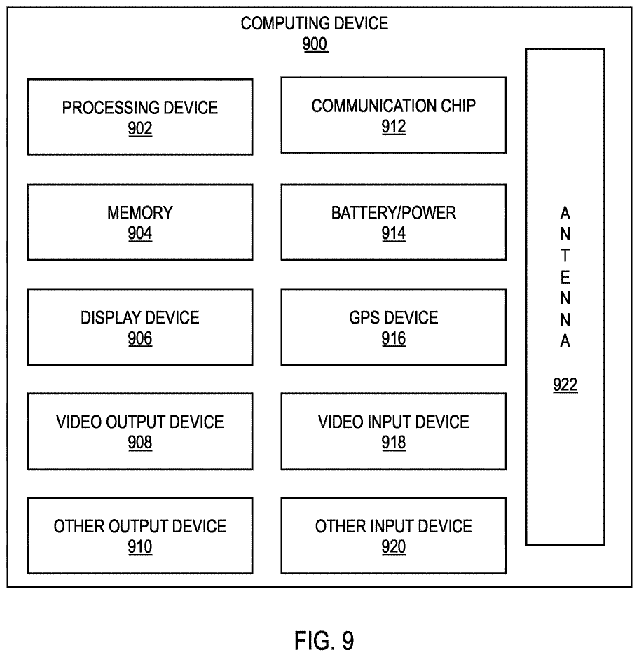

FIG. 8 is a block diagram of an example deep learning system 800, in accordance with various embodiments. The deep learning system 800 trains deep neural networks for various tasks, including neural-guided image enhancement performed on reduced-resolution image data. The deep learning system 800 includes an interface module 810, a neural enhancement model 820, a training module 830, a validation module 840, an inference module 850, and a datastore 860. In other embodiments, alternative configurations, different or additional components may be included in the deep learning system 800. Further, functionality attributed to a component of the deep learning system 800 may be accomplished by a different component included in the deep learning system 800 or a different system. The deep learning system 800 or a component of the deep learning system 800 (e.g., the training module 830 or inference module 850) may include the computing device 900 in FIG. 9.

The interface module 810 facilitates communication of the deep learning system 800 with other systems. As an example, the interface module 810 supports the deep learning system 800 to distribute trained deep neural networks to other systems, e.g., computing devices configured to apply deep neural networks to perform tasks. As another example, the interface module 810 establishes communication between the deep learning system 800 and an external database to receive data that can be used to train deep neural networks or input into deep neural networks to perform tasks. In some embodiments, data received by the interface module 810 may have a data structure, such as a matrix. In some embodiments, data received by the interface module 810 may be an image, a series of images, and/or a video stream.

The neural enhancement model 820 includes one or more trainable components configured to modify reduced-resolution image data to generate a modified small image for use by a neural-guided incorporator. In some examples, the neural enhancement model 820 includes a neural modifier, as described herein. In some examples, the neural enhancement model 820 performs one or more neural-guided image modifications on a low-resolution image, such as color modification, tonal modification, style modification, local recoloring, local white balance, subject relighting, tone mapping, colorization, or background tint adjustment. In general, the neural enhancement model 820 may include a convolutional neural network, U-Net, transformer-based network, semantic segmentation network, tone-mapping network, style-transfer network, or other neural image-modification architecture. The neural enhancement model 820 receives low-resolution image data and generates a modified small image having a desired color, tonal, or style appearance. During training, the neural enhancement model 820 can use ground-truth images, target modified images, semantic-region labels, user-preference targets, tone-mapping targets, style-transfer targets, and/or task-specific loss functions as described herein.

The training module 830 trains deep neural networks by using training datasets. In some embodiments, a training dataset for training a deep neural network may include one or more images and/or videos, each of which may be a training sample. In some examples, the training module 830 trains the neural enhancement model 820. The training module 830 may receive real-world image data for processing with the neural enhancement model 820 as described herein. In some embodiments, the training module 830 trains the neural enhancement model 820 using paired or unpaired training images, semantic-region labels, user-preference values, tone-mapping targets, style targets, or other target image data. In some embodiments, the training module 830 trains the neural enhancement model 820 using a task-specific loss function that penalizes color error, tone error, style error, semantic-region modification error, temporal inconsistencies in video, deviations from natural image properties, or combinations thereof. In some embodiments, the training module 830 may input different data into different layers of the deep neural network. For every subsequent deep neural network layer, the input data may be less than the previous deep neural network layer. In some examples, the neural enhancement model 820 can be trained with ground-truth processed images. In some examples, the difference between the neural enhancement model 820 image output and the corresponding ground-truth image can be measured as a pixel-wise error, perceptual error, color error, tone error, semantic-region error, temporal-consistency error, or another image-quality metric.

In some embodiments, a part of the training dataset may be used to initially train the deep neural network, and the rest of the training dataset may be held back as a validation subset used by the validation module 840 to validate the performance of a trained deep neural network. The portion of the training dataset not including the tuning subset and the validation subset may be used to train the deep neural network.

The training module 830 also determines hyperparameters for training the deep neural network. Hyperparameters are variables specifying the deep neural network training process. Hyperparameters are different from parameters inside the deep neural network (e.g., weights of filters). In some embodiments, hyperparameters include variables determining the architecture of the deep neural network, such as the number of hidden layers, etc. Hyperparameters also include variables that determine how the deep neural network is trained, such as batch size, number of epochs, etc. A batch size defines the number of training samples to work through before updating the parameters of the deep neural network. The batch size is the same as or smaller than the number of samples in the training dataset. The training dataset can be divided into one or more batches. The number of epochs defines how many times the entire training dataset is passed forward and backward through the entire network. The number of epochs defines the number of times that the deep learning algorithm works through the entire training dataset. One epoch means that each training sample in the training dataset has had an opportunity to update the parameters inside the deep neural network. An epoch may include one or more batches. The number of epochs may be 1, 10, 50, 100, or even larger.

The training module 830 defines the architecture of the deep neural network, e.g., based on some of the hyperparameters. The architecture of the deep neural network includes an input layer, an output layer, and a plurality of hidden layers. The input layer of a deep neural network may include tensors specifying attributes of the input image, such as the height of the input image, the width of the input image, and the depth of the input image. The output layer may include a modified small image, one or more semantic-region maps, one or more color-modification maps, one or more tonal-modification maps, one or more style-modification maps, or combinations thereof. The hidden layers are layers between the input layer and output layer. The hidden layers may include one or more convolutional layers and one or more other types of layers, such as pooling layers, fully connected layers, normalization layers, activation layers, softmax or logistic layers, attention layers, upsampling layers, skip-connection layers, or combinations thereof. The convolutional layers of the deep neural network may abstract the input image to a feature map that is represented by a tensor specifying feature map height, feature map width, and feature map channels. A pooling layer may be used to reduce the spatial volume of image data after convolution. A fully connected layer may include weights, biases, and neurons and may be used to generate, select, or condition one or more image-modification outputs or parameters.

In the process of defining the architecture of the deep neural network, the training module 830 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 830 defines the architecture of the deep neural network, the training module 830 inputs a training dataset into the deep neural network. The training dataset includes a plurality of training samples. An example of a training dataset includes a series of images of a video stream. In some embodiments, real-world video frames are input to the neural enhancement model 820 and processed to produce modified small images corresponding to desired color, tonal, or style modifications. In the backward pass, the training module 830 modifies the internal parameters of the deep neural network to minimize a loss function computed between the model-generated output and corresponding target outputs, such as ground-truth modified images, semantic-region targets, tone-mapping targets, style-transfer targets, user-preference targets, or other target outputs. The internal parameters include weights of filters in the convolutional layers of the deep neural network. In some embodiments, the training module 830 uses a cost function to minimize the differences.

The training module 830 may train the deep neural network for a predetermined number of epochs. The number of epochs is a hyperparameter that defines the number of times that the deep learning algorithm will work through the entire training dataset. One epoch means that each sample in the training dataset has had an opportunity to update internal parameters of the deep neural network. After the training module 830 finishes the predetermined number of epochs, the training module 830 may stop updating the parameters in the deep neural network. The deep neural network having the updated parameters is referred to as a trained deep neural network.

The validation module 840 verifies the accuracy of trained deep neural networks. In some embodiments, the validation module 840 inputs samples in a validation dataset into a trained deep neural network and uses the outputs of the deep neural network to determine model accuracy. In some embodiments, a validation dataset may be formed of some or all of the samples in the training dataset. Additionally or alternatively, the validation dataset includes additional samples other than those in the training sets. In some embodiments, the validation module 840 may determine an accuracy score measuring one or more image-quality, modification-accuracy, temporal-consistency, or semantic-preservation metrics of the trained neural enhancement model 820. The validation module 840 may use metrics such as pixel-wise error, perceptual loss, color difference, tone-mapping error, structural similarity, semantic-region preservation, edge preservation, temporal flicker, or a combination thereof to determine the accuracy score.

The validation module 840 may compare the accuracy score with a threshold score. In an example where the validation module 840 determines that the accuracy score of the neural enhancement model 820 is lower than the threshold score, the validation module 840 instructs the training module 830 to re-train the deep neural network. In one embodiment, the training module 830 may iteratively re-train the deep neural network until the occurrence of a stopping condition, such as the accuracy measurement indicating that the deep neural network may be sufficiently accurate, or a number of training rounds having taken place.

The inference module 850 applies the trained or validated deep neural network to perform tasks. The inference module 850 may run inference processes of a trained or validated deep neural network. In some examples, inference makes use of the forward pass to produce model-generated output for unlabeled real-world data. For instance, the inference module 850 may input real-world image or video data into the deep neural network and receive an output of the deep neural network. The output of the deep neural network may include modified small images that include neural-guided color, tonal, or style modifications. The modified small images may be provided to a neural-guided incorporator in an ISP pipeline, where the modified small images are used as guide images to modify corresponding full-resolution images while preserving details from the full-resolution images.

The inference module 850 may aggregate the outputs of the deep neural network to generate a final result of the inference process. In some embodiments, the inference module 850 may distribute the deep neural network to other systems, e.g., computing devices in communication with the deep learning system 800, for the other systems to apply the deep neural network to perform the tasks. The distribution of the deep neural network may be done through the interface module 810. In some embodiments, the deep learning system 800 may be implemented in a server, such as a cloud server, an edge server, and so on. The computing devices may be connected to the deep learning system 800 through a network. Examples of the computing devices include edge devices, client devices, cameras, mobile devices, video conferencing devices, or other devices including or coupled to an image processing pipeline.

The datastore 860 stores data received, generated, used, or otherwise associated with the deep learning system 800. For example, the datastore 860 stores images or video processed by the neural enhancement model 820 or used by the training module 830, validation module 840, and inference module 850. The datastore 860 may also store training images, target modified images, semantic-region labels, style targets, tone-mapping targets, user-preference values, trained parameters of the neural enhancement model 820, and parameters associated with generating modified small images. The datastore 860 may also store parameters associated with a neural-guided incorporator, such as filter coefficients, cutoff frequencies, scaling parameters, blending weights, mask parameters, integration weights, or effect-strength parameters, even where the neural-guided incorporator is not itself trained as a neural network. The datastore 860 may also store other data generated by the training module 830 and validation module 840, such as the hyperparameters for training deep neural networks and internal parameters of trained deep neural networks. In the embodiment of FIG. 8, the datastore 860 is a component of the deep learning system 800. In other embodiments, the datastore 860 may be external to the deep learning system 800 and communicate with the deep learning system 800 through a network.

In general, an untrained or insufficiently trained neural enhancement model 820 may fail to produce modified small images having desired color, tonal, or style characteristics. Such failure may result in incorrect color changes, undesired skin-tone shifts, insufficient tone correction, unnatural style transfer, temporal flickering in video, or other visual artifacts after the modified small images are incorporated into corresponding full-resolution images.

For neural enhancement model 820 training, the input can include an input image frame and corresponding training targets, such as target color-modified images, target tone-mapped images, target style-transferred images, semantic-region labels, masks, user-preference values, or labeled ground-truth processed images. In various examples, the input image frame is received at an image processing system, such as the image processing system 100 and/or the neural enhancement model 820. In other examples, the input image frame can be received at the training module 830 or the inference module 850 of FIG. 8. The imager can be a camera, such as a video camera. The input image frame can be a still image from the video camera feed. The input image frame can include a matrix of pixels, each pixel having a color, lightness, and/or other parameter. The input image frame can be downscaled and processed by a pre-processing block. Various steps can be repeated to further adjust the neural enhancement model 820 parameters. In some examples, the training can be repeated with a new input image frame and corresponding training targets.

Example Computing Device FIG. 9 is a Block Diagram of an Example Computing Device 900, in accordance with various embodiments. In some embodiments, the computing device 900 may be used for at least part of the deep learning system 800 in FIG. 8. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or a video output device 908 may be coupled. The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 904 may include memory that shares a die with the processing device 902. In some embodiments, the memory 904 includes one or more non-transitory computer-readable media storing instructions executable for neural-guided color, tonal, and/or style enhancement in an image processing pipeline, e.g., the methods 600, 700, 750 described above in conjunction with FIGS. 6, 7A, and 7B or some operations performed by the deep learning system 800 in FIG. 8. The instructions stored in the one or more non-transitory computer-readable media may be executed by the processing device 902. In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some embodiments they might not. The communication chip 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions). In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications. The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power). The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example. The computing device 900 may include a video output device 908 (or corresponding interface circuitry, as discussed above). The video output device 908 may include a graphics processor, display controller, video encoder, video codec, display interface, projector interface, monitor interface, or another component configured to generate or output image or video data. The computing device 900 may include a video input device 918 (or corresponding interface circuitry, as discussed above). The video input device 918 may include a camera, image sensor, video decoder, image capture interface, MIPI camera interface, or another component configured to receive or generate image or video data. The computing device 900 may include a GPS device 916 (or corresponding interface circuitry, as discussed above). The GPS device 916 may be in communication with a satellite-based system and may receive a location of the computing device 900, as known in the art. The computing device 900 may include another output device 910 (or corresponding interface circuitry, as discussed above). Examples of the other output device 910 may include a video codec, a printer, a wired or wireless transmitter for providing information to other devices, or an additional storage device. In some embodiments, the computing device 900 may include an audio output device, such as one or more speakers, headphones, earbuds, or audio interface circuitry. The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader. In some embodiments, the computing device 900 may include an audio input device, such as one or more microphones, microphone arrays, or audio interface circuitry. The computing device 900 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### Selected Examples

The following paragraphs provide various examples of the embodiments disclosed herein.

Example 1 provides an apparatus, including an image signal processing (ISP) pipeline including a high-resolution processing path, the ISP pipeline to receive an input image and generate a reduced-resolution image corresponding to the input image; a neural modifier to process the reduced-resolution image and generate a modified small image; a neural-guided incorporator in the high-resolution processing path to: receive the modified small image and a high-resolution version of the input image, combine appearance information from the modified small image and detail information from the high-resolution image, and generate a high-resolution output image.

Example 2 provides the apparatus of example 1, where the appearance information includes at least one of a color modification, a tonal modification, and a style modification.

Example 3 provides the apparatus of example 1 or 2, where the detail information is generated at one or more spatial frequency levels or resolution levels.

Example 4 provides the apparatus of any one of examples 1-3, where the high-resolution output image includes at least one of the color modification, the tonal modification, and the style modification represented by the modified small image and preserves at least one of texture and edge detail from the high-resolution version of the input image.

Example 5 provides the apparatus of any one of examples 1-4, where the neural-guided incorporator includes a finite impulse response (FIR) filter arrangement configured to combine the appearance information from the modified small image with the detail information from the high-resolution version of the input image.

Example 6 provides the apparatus of example 5, where the FIR filter arrangement includes a scaler to scale the modified small image; a low-pass filter to generate low-frequency appearance information from the scaled modified small image; a high-pass filter to generate high-frequency detail information from the high-resolution version of the input image; and a combiner to combine the low-frequency appearance information and the high-frequency detail information.

Example 7 provides the apparatus of example 6, where the low-pass filter and the high-pass filter are configured based on one or more filter parameters.

Example 8 provides the apparatus of example 7, where the one or more filter parameters include at least one of filter coefficients, filter sizes, cutoff frequencies, gains, blending weights, and effect-strength parameters.

Example 9 provides the apparatus of any one of examples 6-8, where the neural-guided incorporator is to apply one or more weights, masks, or effect-strength parameters to at least one of the low-frequency appearance information, the high-frequency detail information, and an output of the combiner.

Example 10 provides the apparatus of any one of examples 1-9, where the neural-guided incorporator includes a pyramid filter arrangement to generate a multi-resolution representation of the high-resolution version of the input image and integrate the modified small image into the multi-resolution representation.

Example 11 provides the apparatus of example 10, where the pyramid filter arrangement includes one or more Gaussian filters and one or more downsamplers to generate a plurality of pyramid levels from the high-resolution version of the input image.

Example 12 provides the apparatus of example 10 or 11, where the pyramid filter arrangement is to extract a plurality of detail components from the high-resolution version of the input image at multiple pyramid levels.

Example 13 provides the apparatus of example 12, where the pyramid filter arrangement is to integrate the modified small image at a selected pyramid level and reconstruct the high-resolution output image by successively upsampling from the selected pyramid level and adding the plurality of detail components.

Example 14 provides the apparatus of example 13, where integrating the modified small image at the selected pyramid level includes at least one of replacing, blending, averaging, interpolating, weighting, and mask-based combining the modified small image with a pyramid-level representation derived from the high-resolution version of the input image.

Example 15 provides one or more non-transitory computer-readable media storing instructions executable to perform operations, the operations including receiving an input image at an image signal processing (ISP) pipeline including a high-resolution processing path; generating a reduced-resolution image corresponding to the input image; processing, at a neural modifier, the reduced-resolution image to generate a modified small image; receiving, at a neural-guided incorporator in the high-resolution processing path, the modified small image and a high-resolution version of the input image; and combining appearance information from the modified small image and detail information from the high-resolution image to generate a high-resolution output image.

Example 16 provides the one or more non-transitory computer-readable media of example 15, where the appearance information includes at least one of a color modification, a tonal modification, or a style modification, and where the high-resolution output image includes the at least one of the color modification, the tonal modification, or the style modification represented by the modified small image and preserves at least one of texture or edge detail from the high-resolution version of the input image.

Example 17 provides the one or more non-transitory computer-readable media of example 15 or 16, where the detail information is generated at one or more spatial frequency levels or resolution levels.

Example 18 provides the one or more non-transitory computer-readable media of any one of examples 15-17, where combining the appearance information from the modified small image and the detail information from the high-resolution image includes combining, at a finite impulse response (FIR) filter arrangement, the appearance information from the modified small image with the detail information from the high-resolution version of the input image.

Example 19 provides the one or more non-transitory computer-readable media of example 18, where combining the appearance information from the modified small image and the detail information from the high-resolution image includes scaling the modified small image; generating, using a low-pass filter, low-frequency appearance information from the scaled modified small image; generating, using a high-pass filter, high-frequency detail information from the high-resolution version of the input image; and combining the low-frequency appearance information and the high-frequency detail information.

Example 20 provides the one or more non-transitory computer-readable media of example 19, where low-pass filter parameters for the low-pass filter and high-pass filter parameters for the high-pass filter are jointly selected.

Example 21 provides the one or more non-transitory computer-readable media of example 20, where the jointly selected low-pass filter parameters and high-pass filter parameters include at least one of filter coefficients, filter sizes, cutoff frequencies, gains, blending weights, or effect-strength parameters.

Example 22 provides the one or more non-transitory computer-readable media of any one of examples 19-21, where the operations further include applying one or more weights, masks, or effect-strength parameters to at least one of the low-frequency appearance information, the high-frequency detail information, or an output generated by combining the low-frequency appearance information and the high-frequency detail information.

Example 23 provides the one or more non-transitory computer-readable media of any one of examples 15-22, where combining the appearance information from the modified small image and the detail information from the high-resolution image includes combining using a pyramid filter arrangement, generating a multi-resolution representation of the high-resolution version of the input image, and integrating the modified small image into the multi-resolution representation.

Example 24 provides the one or more non-transitory computer-readable media of example 23, where generating the multi-resolution representation includes applying one or more Gaussian filters and one or more downsamplers to the high-resolution version of the input image to generate a plurality of pyramid levels.

Example 25 provides the one or more non-transitory computer-readable media of example 23 or 24, where the operations further include extracting a plurality of detail components from the high-resolution version of the input image at multiple pyramid levels.

Example 26 provides the one or more non-transitory computer-readable media of example 25, where the operations further include integrating the modified small image at a selected pyramid level and reconstructing the high-resolution output image by successively upsampling from the selected pyramid level and adding the plurality of detail components.

Example 27 provides the one or more non-transitory computer-readable media of example 26, where integrating the modified small image at the selected pyramid level includes replacing, blending, averaging, interpolating, weighting, or mask-based combining the modified small image with a pyramid-level representation derived from the high-resolution version of the input image.

Example 28 provides a computer-implemented method, including receiving an input image at an image signal processing (ISP) pipeline including a high-resolution processing path and a reduced-resolution processing path; generating a reduced-resolution image corresponding to the input image; processing, at a neural modifier in the reduced-resolution processing path, the reduced-resolution image to generate a modified small image; receiving, at a neural-guided incorporator in the high-resolution processing path, the modified small image and a high-resolution version of the input image; and combining appearance information from the modified small image and detail information from the high-resolution image to generate a high-resolution output image.

Example 29 provides the computer-implemented method of example 28, where the appearance information includes at least one of a color modification, a tonal modification, or a style modification, and where the high-resolution output image includes the at least one of the color modification, the tonal modification, or the style modification represented by the modified small image and preserves at least one of texture or edge detail from the high-resolution version of the input image.

Example 30 provides the computer-implemented method of example 28 or 29, where the detail information is generated at one or more spatial frequency levels or resolution levels.

Example 31 provides the computer-implemented method of any one of examples 28-30, where combining the appearance information from the modified small image and the detail information from the high-resolution image includes combining, at a finite impulse response filter arrangement, the appearance information from the modified small image with the detail information from the high-resolution version of the input image.

Example 32 provides the computer-implemented method of example 31, where combining the appearance information from the modified small image and the detail information from the high-resolution image includes scaling the modified small image; generating, using a low-pass filter, low-frequency appearance information from the scaled modified small image; generating, using a high-pass filter, high-frequency detail information from the high-resolution version of the input image; and combining the low-frequency appearance information and the high-frequency detail information.

Example 33 provides the computer-implemented method of example 32, where low-pass filter parameters for the low-pass filter and high-pass filter parameters for the high-pass filter are jointly selected.

Example 34 provides the computer-implemented method of example 33, where the jointly selected low-pass filter parameters and high-pass filter parameters include at least one of filter coefficients, filter sizes, cutoff frequencies, gains, blending weights, or effect-strength parameters.

Example 35 provides the computer-implemented method of any one of examples 32-34, further including applying one or more weights, masks, or effect-strength parameters to at least one of the low-frequency appearance information, the high-frequency detail information, or an output generated by combining the low-frequency appearance information and the high-frequency detail information.

Example 36 provides the computer-implemented method of any one of examples 28-35, where combining the appearance information from the modified small image and the detail information from the high-resolution image includes combining using a pyramid filter arrangement, generating a multi-resolution representation of the high-resolution version of the input image, and integrating the modified small image into the multi-resolution representation.

Example 37 provides the computer-implemented method of example 36, where generating the multi-resolution representation includes applying one or more Gaussian filters and one or more downsamplers to the high-resolution version of the input image to generate a plurality of pyramid levels.

Example 38 provides the computer-implemented method of example 36 or 37, further including extracting a plurality of detail components from the high-resolution version of the input image at multiple pyramid levels.

Example 39 provides the computer-implemented method of example 38, further including integrating the modified small image at a selected pyramid level and reconstructing the high-resolution output image by successively upsampling from the selected pyramid level and adding the plurality of detail components.

Example 40 provides the computer-implemented method of example 39, where integrating the modified small image at the selected pyramid level includes replacing, blending, averaging, interpolating, weighting, or mask-based combining the modified small image with a pyramid-level representation derived from the high-resolution version of the input image.

Example 41 provides a method of processing an image, including receiving, by an image processing pipeline, a full-resolution image; generating, from the full-resolution image or from image data corresponding to the full-resolution image, a reduced-resolution image; generating, using a neural image modifier, a modified reduced-resolution image from the reduced-resolution image, the modified reduced-resolution image representing at least one of a color modification, a tonal modification, or a style modification; providing the full-resolution image and the modified reduced-resolution image to a neural-guided incorporator disposed in a color or tonal processing stage of the image processing pipeline; by the neural-guided incorporator, incorporating the modified reduced-resolution image into the full-resolution image by applying visual appearance information from the modified reduced-resolution image to the full-resolution image while preserving spatial detail information from the full-resolution image; and outputting a processed full-resolution image having the at least one of the color modification, the tonal modification, or the style modification represented by the modified reduced-resolution image and having texture or edge detail from the full-resolution image.

Example 42 provides an image processing apparatus, including one or more processors or hardware processing circuits configured to implement an image processing pipeline, the image processing pipeline including a neural-guided incorporator configured to receive a full-resolution image and a modified reduced-resolution guide image generated by neural processing of a reduced-resolution image; where the neural-guided incorporator includes an upscaler configured to upscale the modified reduced-resolution guide image; a low-pass filter configured to generate low-frequency visual appearance information from the upscaled modified reduced-resolution guide image; a high-pass filter configured to generate high-frequency detail information from the full-resolution image; and a combiner configured to combine the low-frequency visual appearance information and the high-frequency detail information to generate a processed full-resolution image, where the processed full-resolution image includes at least one color, tonal, or style modification from the modified reduced-resolution guide image and preserves texture or edge detail from the full-resolution image.

Example 43 provides an image processing system, including a reduced-resolution processing path configured to provide a reduced-resolution image to a neural image modifier, the neural image modifier being configured to generate a modified reduced-resolution image having a desired visual appearance; a full-resolution image processing path configured to process a full-resolution image corresponding to the reduced-resolution image; and a neural-guided incorporator, the neural-guided incorporator being configured to generate a processed full-resolution image by: generating a multi-resolution representation of the full-resolution image including a plurality of detail components at different resolution levels; integrating the modified reduced-resolution image into a selected resolution level of the multi-resolution representation; and reconstructing the processed full-resolution image from the selected resolution level and the plurality of detail components, where the processed full-resolution image has colors, tones, or style corresponding to the modified reduced-resolution image and has details corresponding to the full-resolution image.

Example 44 provides a computer-implemented method for incorporating neural-guided image modifications into an image processing pipeline, the method including generating a small image from a raw input image captured by a sensor, where the small image is a low-resolution version of the raw input image; processing the small image using a neural modifier to produce a modified small image, where the neural modifier applies one or more of color, tonal, or style modifications to the small image; receiving, by a neural-guided incorporator positioned within a color and tonal processing stage of the image processing pipeline, the modified small image and a full-resolution version of the raw input image; and fusing, by the neural-guided incorporator, the modified small image with the full-resolution version of the raw input image to produce a full-resolution output image that incorporates the color, tonal, or style modifications of the modified small image while preserving spatial detail and texture of the full-resolution version of the raw input image.

Example 45 provides a system for incorporating neural-guided image modifications into an image processing pipeline, the system including a neural modifier configured to receive a small image derived from a raw input image and produce a modified small image by applying one or more color, tonal, or style modifications to the small image; and a neural-guided incorporator embedded within a color and tonal processing stage of the image processing pipeline, the neural-guided incorporator including an upscaler configured to upscale the modified small image to a resolution of a full-resolution version of the raw input image; a low-pass filter configured to extract low-frequency content from the upscaled modified small image; and a high-pass filter configured to extract high-frequency content from the full-resolution version of the raw input image, where the high-pass filter and the low-pass filter are jointly designed to be spectrally complementary; where the neural-guided incorporator is configured to combine outputs of the low-pass filter and the high-pass filter to produce a full-resolution output image.

Example 46 provides a system for incorporating neural-guided image modifications into an image processing pipeline, the system including a neural modifier configured to receive a small image derived from a raw input image and produce a modified small image by applying one or more color, tonal, or style modifications to the small image; and a neural-guided incorporator embedded within a color and tonal processing stage of the image processing pipeline, the neural-guided incorporator configured to: construct a multi-scale Laplacian pyramid representation of a full-resolution version of the raw input image by iteratively applying Gaussian blurring and subsampling to produce a plurality of resolution levels, and computing a detail band at each resolution level by subtracting the blurred version from the image at that resolution level; inject the modified small image at a coarsest resolution level of the Laplacian pyramid by replacing or blending the coarsest resolution level with the modified small image; and reconstruct the full-resolution output image by progressively upsampling and adding detail bands from each resolution level of the Laplacian pyramid back to the image, whereby color and tonal content from the modified small image is incorporated into the full-resolution output image while spatial detail from the full-resolution version of the raw input image is preserved.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
an image signal processing (ISP) pipeline including a high-resolution processing path, the ISP pipeline to receive an input image and generate a reduced-resolution image corresponding to the input image;
a neural modifier to process the reduced-resolution image and generate a modified small image;
a neural-guided incorporator in the high-resolution processing path to:
receive the modified small image and a high-resolution version of the input image,
combine appearance information from the modified small image and detail information from the high-resolution image, and
generate a high-resolution output image.

2. The apparatus of claim 1, wherein the appearance information includes at least one of a color modification, a tonal modification, and a style modification.

3. The apparatus of claim 1, wherein the detail information is generated at one or more spatial frequency levels or resolution levels.

4. The apparatus of claim 1, wherein the high-resolution output image includes at least one of a color modification, a tonal modification, and a style modification represented by the modified small image and preserves at least one of texture and edge detail from the high-resolution version of the input image.

5. The apparatus of claim 1, wherein the neural-guided incorporator includes a finite impulse response (FIR) filter arrangement configured to combine the appearance information from the modified small image with the detail information from the high-resolution version of the input image.

6. The apparatus of claim 5, wherein the FIR filter arrangement includes:
a scaler to scale the modified small image;
a low-pass filter to generate low-frequency appearance information from the scaled modified small image;
a high-pass filter to generate high-frequency detail information from the high-resolution version of the input image; and
a combiner to combine the low-frequency appearance information and the high-frequency detail information.

7. The apparatus of claim 6, wherein the low-pass filter and the high-pass filter are configured based on one or more filter parameters.

8. The apparatus of claim 7, wherein the one or more filter parameters include at least one of filter coefficients, filter sizes, cutoff frequencies, gains, blending weights, and effect-strength parameters.

9. The apparatus of claim 6, wherein the neural-guided incorporator is to apply one or more weights, masks, or effect-strength parameters to at least one of the low-frequency appearance information, the high-frequency detail information, and an output of the combiner.

10. The apparatus of claim 1, wherein the neural-guided incorporator includes a pyramid filter arrangement to generate a multi-resolution representation of the high-resolution version of the input image and integrate the modified small image into the multi-resolution representation.

11. The apparatus of claim 10, wherein the pyramid filter arrangement includes one or more Gaussian filters and one or more downsamplers to generate a plurality of pyramid levels from the high-resolution version of the input image.

12. The apparatus of claim 10, wherein the pyramid filter arrangement is to extract a plurality of detail components from the high-resolution version of the input image at multiple pyramid levels.

13. The apparatus of claim 12, wherein the pyramid filter arrangement is to integrate the modified small image at a selected pyramid level and reconstruct the high-resolution output image by successively upsampling from the selected pyramid level and adding the plurality of detail components.

14. The apparatus of claim 13, wherein integrating the modified small image at the selected pyramid level includes at least one of replacing, blending, averaging, interpolating, weighting, and mask-based combining the modified small image with a pyramid-level representation derived from the high-resolution version of the input image.

15. One or more non-transitory computer-readable media storing instructions executable to perform operations, the operations comprising:
receiving an input image at an image signal processing (ISP) pipeline including a high-resolution processing path;
generating a reduced-resolution image corresponding to the input image;
processing, at a neural modifier, the reduced-resolution image to generate a modified small image;
receiving, at a neural-guided incorporator in the high-resolution processing path, the modified small image and a high-resolution version of the input image; and
combining appearance information from the modified small image and detail information from the high-resolution image to generate a high-resolution output image.

16. The one or more non-transitory computer-readable media of claim 15, wherein combining the appearance information from the modified small image and the detail information from the high-resolution image comprises combining, at a finite impulse response filter arrangement, the appearance information from the modified small image with the detail information from the high-resolution version of the input image.

17. The one or more non-transitory computer-readable media of claim 16, wherein the operations further comprise:
scaling the modified small image;
generating, using a low-pass filter, low-frequency appearance information from the scaled modified small image;
generating, using a high-pass filter, high-frequency detail information from the high-resolution version of the input image; and
combining the low-frequency appearance information and the high-frequency detail information.

18. The one or more non-transitory computer-readable media of claim 15, wherein combining the appearance information from the modified small image and the detail information from the high-resolution image includes:
combining using a pyramid filter arrangement,
generating a multi-resolution representation of the high-resolution version of the input image, and
integrating the modified small image into the multi-resolution representation.

19. The one or more non-transitory computer-readable media of claim 18, wherein the operations further comprise:
extracting a plurality of detail components from the high-resolution version of the input image at multiple pyramid levels;
integrating the modified small image at a selected pyramid level; and
reconstructing the high-resolution output image by successively upsampling from the selected pyramid level and adding the plurality of detail components.

20. A computer-implemented method, comprising:
receiving an input image at an image signal processing (ISP) pipeline including a high-resolution processing path;
generating a reduced-resolution image corresponding to the input image;
processing, at a neural modifier, the reduced-resolution image to generate a modified small image;
receiving, at a neural-guided incorporator in the high-resolution processing path, the modified small image and a high-resolution version of the input image; and
combining appearance information from the modified small image and detail information from the high-resolution image to generate a high-resolution output image.
